(19) United States
(12) Patent Application Publication
(10) Pub. No.: US 2014/0019285 A1
(43) Pub. Date: Jan. 16, 2014

(54) Dynamic Listing Recommendation

(71) Applicants: Venkateswaran Subramanian Karthik, Santa Clara, CA (US); Ritu Narayan, Cupertino, CA (US); Srinivasan Raman, Cupertino, CA (US); Aswath Ayyala, Fremont, CA (US); Adhish Vyas, San Jose, CA (US); Bhupendra Jain, Santa Clara, CA (US)

(72) Inventors: Venkateswaran Subramanian Karthik, Santa Clara, CA (US); Ritu Narayan, Cupertino, CA (US); Srinivasan Raman, Cupertino, CA (US); Aswath Ayyala, Fremont, CA (US); Adhish Vyas, San Jose, CA (US); Bhupendra Jain, Santa Clara, CA (US)

(21) Appl. No.: 13/916,247

(22) Filed: Jun. 12, 2013

Related U.S. Application Data
(60) Provisional application No. 61/671,503, filed on Jul. 13, 2012.

(51) Int. Cl. G06Q 30/08

(52) U.S. Cl. CPC G06Q 30/08
USPC 705/26.3

(57) ABSTRACT

Methods and systems are provided for attempting to optimize online listings for users of an Internet sales website, such as an online auction website. Recommendations can be provided to the users for improving their listings. The recommendations can be made using rules and statistical models. The listings can be monitored for compliance with the recommendations. The listings can be monitored for effectiveness of such compliance. The rules can be modified in light of such effectiveness. In this manner, listings can tend to be optimized so as to increase the likelihood of a visit from a potential buyer resulting in conversion.

### PRIORITY CLAIM

This patent application claims the benefit of the priority date of U.S. provisional patent application Ser. No. 61/671,503, filed on Jul. 13, 2012 and pursuant to 35 USC 119. The entire contents of this provisional patent application are hereby expressly incorporated by reference.

### BACKGROUND

1. Technical Field

The present disclosure generally relates to electronic commerce and, more particularly, relates to methods and systems for enhancing the quality of online user listings.

2. Related Art

The quality of online listings for products being sold via Internet sales or commerce websites, including auction websites such as eBay, can substantially affect the sales of such products. Those online listings having better quality tend to attract more potential buyers, keep the potential buyers interested longer, and convert more of the potential buyers into actual buyers. The online listings with higher quality also sell faster, command more trust from the potential buyers, and command better sales prices compared to lower quality listings of similar items on sale.

However, such Internet commerce websites can have a large number of users. Further, each user can have many different online listings. The large number of users coupled with the number of online listings for each user can result in a very large number of online listings. There can simply be too many online listings to review and critique.

Despite the advantages of doing so, maintaining the desired quality for such a large number of the online listings can be a substantial challenge. Thus, users typically receive little or no feedback regarding the quality of their listings. The buyer expectations of what helps them make faster purchase decisions rapidly evolves over time and the notion of what constitutes a good quality level for listings evolves as the buyer expectations and behavior evolves. This makes it even harder to provide offline and manual feedback to users about the quality of their listings.

### BRIEF DESCRIPTION OF THE DRAWINGS

FIG. 1 is a block diagram of a system for providing dynamic listing recommendations according to an embodiment;

FIG. 2 is a block diagram of an architecture for the system for providing dynamic listing recommendations, according to an embodiment;

FIG. 3 is a flow chart of the method for providing dynamic listing recommendations, according to an embodiment;

FIG. 4 is a block diagram of an example of a computer that is suitable for use in the system for providing dynamic listing recommendations, according to an embodiment;

FIG. 5 is a flow chart of a method for providing picture guidance according to the method for dynamic listing recommendations, according to an embodiment;

FIG. 6 is an example of a picture quality score provided by the method for providing dynamic listing recommendations, according to an embodiment; and

FIG. 7 is an example of a seller policy score provided by the method for providing dynamic listing recommendations, according to an embodiment.

### DETAILED DESCRIPTION

Assuring the optimization of each online listing for each user using an Internet sales website or the like is a daunting task. Assuring the optimization of an online listing can include reviewing aspects of the listing that can affect the quality of the listing. That is, assuring the optimization of an online listing can include checking any aspects of the listing that can affect the ability of the listing to result in conversion, i.e., a sale.

The sheer number of such online listings can substantially prohibit the human review and critiquing of every listing. However, it is important that an effort be made to optimize such online listings. The sale of listed products tends to bear a direct relationship to the quality of their listings. Listings that grab a potential customer's attention and that provide information that the potential customer is looking for are substantially more likely to convert a potential customer into an actual customer.

Often, users lack a clear idea regarding what is really important to their customers for making an instant purchase decision. If an instant purchase decision is not made, the sale is frequently lost. Therefore, it is important that a potential customer decide to make a purchase when first viewing an online listing for the product.

Users may base their ideas regarding how products should be listed upon a review of a small sample of completed listings. This is often done in an attempt to determine what has worked in the past to sell comparable products. These sample listings may be taken from approximately the same period time, e.g., from the last six months. These sample listings may be taken from a single user or a small group of users. These sample listings may be taken from a single Internet auction or commerce website.

Thus, the samples upon which users may base their opinions may not be broad enough to provide the necessary information. The time period may not be long enough and thus may contain skewed data. For example, the skewed data may be from a particular time period, e.g., pre-Christmas, such that the skewed data is not generally applicable. There is often no guarantee that the time period for the sample listings is relevant to the user's listing.

Further, data taken from a small number of listings may not be representative of overall listing performance. For example, the small number of listings may be associated with a seller that has a loyal customer base that provides sales performance which is not readily duplicated. There is no guarantee that the seller conforms to good listing practices.

Yet further, the listings may be taken from a single Internet auction or commerce website and the general performance of that single Internet auction or commerce website may be exceptional. The Internet auction or commerce website from which the samples are taken may have a loyal customer base that provides sales performance which is not readily duplicated. Further, there is no guarantee that the Internet auction or commerce website from which the samples are taken conforms to good listing practices.

Therefore, relying upon a small sample of listings may not provide accurate information for attempting to optimize a user's new listing. There is no simply no guarantee that the use of such a small sample of listings will provide the information necessary to optimize the user's new or existing listing.

For example, the user may review sample listings from last summer when attempting to make sales just prior to Christmas. Of course, seasonality can have a substantial influence upon online listing optimization. As a further example, the user may review sample listings from a seller who is not skilled at listing products for sell via Internet auctions or commerce websites. Thus, the sample listings may not be optimized and may very well be poor examples of what attributes a listing should have.

Attempts to have users optimize their online listings can present various challenges. Users, even when they know what the best practices are, often cannot translate that knowledge into the insights and practices necessary for them to take the appropriate action regarding their listings. Merely providing educational tools regarding best practices is a start, but too often does not result in provoking the desired actions on the part of users. Thus, users frequently need additional guidance regarding the implementation of best practices.

However, a contemporary lack of easily used tools and mechanisms for implementing best practice recommendations to users tends to exacerbate the problem. Thus, according to contemporary practice, users tend to be left to their own devices when it comes to listing their products for sale on such Internet websites. Being left on their own typically results in users reviewing a few sample listings and then basing their own listings on the sample listings, as discussed above. According to contemporary practice, there is no simple, easy to use mechanism by which users can determine how many of their listings are suboptimal, what the deficiencies with such listings are, and how to cure such deficiencies.

This problem is compounded for those users who have good til cancelled (GTC) listings. Users with good til cancelled listings can have a large number of online listings. Of course, having a large number of listings can make the optimization thereof substantially more difficult. When the buyer behavior has evolved, and the notion of quality has changed, the good till cancelled listed in past, even when it conformed to the quality standards of the time at which it was listed, suddenly now becomes lower quality. For example, a good till cancelled listing may have been listed several months ago when providing returns policy and free shipping for goods sold online may not be an industry standard and thus buyers then were not basing their purchase decision based on whether or not the item offered a free shipping and returns. However, fast forward time, industry standards evolved, and competitors provide free shipping and attractive returns policy for good sold online, buyer expectations suddenly change, and they expect a good quality listing to have a free shipping option and a returns option. Given this change in the buyer expectation, now users would need to be educated on the need to improve the quality of their good till cancelled listing listed several months ago without a free shipping and returns option. However, users find it extremely hard, if not impossible, to review hundreds of their listings manually and identify the listings without return policy or free shipping, and update the information to improve the quality of the listings.

Thus, users are often unable to provide high quality listings. The resulting poor quality listings can cause poor shopping experiences for customers, poor or no sales for users, and can adversely impact the profitability and reputation of the online merchant or auction or commerce website. Thus, a positive benefit can be provided to customers, users, and online merchants when listing quality is improved.

Generally, the user's listings can be considered to vary in quality along four separate dimensions. First, the quality of structured information can vary. Second, the quality of unstructured information can vary. Third, the quality of the user's policies can vary. Fourth, image quality can vary substantially.

Structured information can include more standard information such as product name, model number, manufacturer, and the like. This information can vary from product to product, but tends to exist for most products and can readily be stored in a database and/or displayed in a listing. Unstructured information can include a description of the product and reviews of the product. Such unstructured information is often less readily categorized.

According to an embodiment, a dynamic listing recommendation system can determine what is important to buyers in the relevant category (e.g., sporting goods, clothing consumer electronics, home appliances, etc.) and can evaluate the listing to provide a score of the listing, such as relative to similar listings. The listing can be scored during and/or after submission. A numerical value (for example, 1-100) and/or an alphabetic value (for example, A, B, C, D, or F) can be associated with the score.

According to an embodiment, the dynamic listing recommendation system can provide personalized and prioritized recommendations as to how the user might improve the listing. For example, the dynamic listing recommendation system might recommend the use of more text, less text, more photographs and/or better photographs. The dynamic listing recommendation system can provide recommendations regarding any dimension or combination of dimensions of quality for any desired category of listing.

According to an embodiment, the dynamic listing recommendation system can share other users' scores with the user so that the user can learn where the user stands regarding quality with respect to other users. The users score can be interpreted based on an absolute scale based on what the system computes to be the best score. For example, if the user's core is 67 out of 100, then 100 is the best score the user can obtain on an absolute level. However, the average or median scores of other users could be 79 out of 100, and the user can now see where stands compared to his competitors.

The dynamic listing recommendation system can share specific other sellers' scores so that the user can learn how the user's listing compares to such specific other sellers' listings. The user can specify which other sellers' scores and/or which other sellers' listings are to be shared. The dynamic listing recommendation system can share other sellers' scores generally (such as by sharing an average of the other sellers' scores) so that the user can learn how the user's listing compares to other sellers' listings in general.

According to an embodiment, the dynamic listing recommendation system can populate or substitute structured content for the unstructured content in the listing, e.g., brand. The dynamic listing recommendation system can automatically populate structured content for the unstructured content in the listing. For example, the dynamic listing recommendation system can provide a specific brand name when none is provided in the listing. The dynamic listing recommendation system can correlate product names, models numbers, product details, and the like with other information, such as brand name, as store in a database or provide on the Internet, for example.

Other sellers' information, e.g., listings, can be categorized and shared in any desired manner. For example, the user may be interested only in other sellers within a defined geographic area, e.g., city, state, region, or country. As a further example, the user may be interested only in other sellers for a particular product category (e.g., sporting goods, clothing consumer electronics, home appliances, etc.). As yet a further example, the user may be interested only in the other sellers for a define period of time (e.g., last month, last year, from 2002 to 2005, etc.). Thus, according to an embodiment, such sharing can be tailored to the user's desire for such information.

According to an embodiment, a system can facilitate a financial transaction over a network. The system can comprise a memory for storing user account information. The information can comprise listing information for a product listed or sold that is associated with a user account. One or more processors can be in communication with the memory.

The one or more processors can be adapted to receive, from a user, information about a product for listing with a service provider, such as an online seller and/or online auction or commerce website. The one or more processors can present a recommendation to the user for revising the information. The one or more processors can determine whether the user made or implemented the recommendation and store data corresponding to whether the user implemented the recommendation.

The information regarding whether or not the user implemented the recommendation can be used to enhance the dynamic listing recommendation system. For example, recommendations that are never or rarely implemented can be omitted (not provided to the user) in the future. As a further example, recommendations that are never or rarely implemented can be analyzed, such as by a person or a machine to determine why they are never or rarely implemented. The person or machine can attempt to improve such recommendations.

The one or more processors can receive revised information for the product. The one or more processors can list the product on behalf of the user based on the revised information. The revised information can be updated information from the user, from a database, from a product manufacturer, from product literature, from a user manual, from the Internet, from the manufacturer's website, or from any other source.

The one or more processors can determine what recommendation or recommendations to make for the user. Each recommendation can be based on user actions from previous recommendations, listing information for a related product, and/or type of product, for example.

The information can comprise a written description, a photo, a Uniform (or Universal) Product Code (UPC), and a price, for example. The information can comprise any other information regarding the listing. The information can comprise information regarding a product, such as a product being sold via the listing.

The recommendation can be amended or add a written description, a photo, a UPC code, and/or a price, for example. The recommendation can be used to revise, e.g., amend or add, any other information, formatting, appearance, or change to the listing.

The recommendation can be based, at least in part, on one or more previous successful or sold listings. For example, the recommendation can be based, at least in part, on one or more previous successful or sold listings of related product from the same or a different user. The recommendation can be based, at least in part, on one or more previous unsuccessful or unsold listings. For example, the recommendation can be based, at least in part, on one or more previous unsuccessful or unsold listings of related product from the same or a different user.

The data can be used to make a subsequent recommendation to the user. The data can be used to automatically implement a change to the user's listing. The data can be used for any other desired purpose.

The recommendation can be based, at least in part, on qualitative and quantitative data for buyer actions such click stream behavior on one or more previous successful or sold listings and comparable behavior unsold listings, and user experience research. For example, the recommendation can be based, at least in part, on how buyers click on listings based on quality levels, or visual heat maps of aggregate data of large number of buyers on what areas of listing information the buyers dwell most while reviewing the listings. Based on such data at the disposal of the system, the system can determine that buyers tend to look at pictures more for collectible or clothing and fashion category items, whereas for new electronic commodity goods, the buyers look less on pictures but more on the technical specifications of the items on sale. Based on this inference, the system can generate recommendations that emphasizes more weight for providing high quality images for collectibles or fashion category items and more weight for higher quality structured data such as model, brand, technical performance data for commodity electronic goods such as game consoles or smartphones.

According to an embodiment, a non-transitory machine-readable medium can comprise a plurality of machine-readable instructions. The machine-readable instructions can, when executed by one or more processors of a server, be adapted to cause the server to perform a method. The method can comprise receiving, such as from a user, information about a product for listing with a service provider. A recommendation can be presented, such as to the user, for revising the information. A determination can be made as to whether or not the user implemented the recommendation. The user or anyone else can make the determination. The determination can be made by a machine, e.g., a computer. Data can be stored corresponding to whether or not the user implemented the recommendation.

The method further can comprise receiving revised information for the product and listing the product on behalf of the user based on the revised information. The one or more processors can determine what recommendation to make for the user based on user actions from previous recommendations, listing information for a related product, and/or the type of product.

The information can comprise a written description, a photo, a UPC code, and/or a price, for example. The recommendation can be to revise, e.g., amend or add, a written description, a photo, a UPC code, and/or a price, for example. The recommendation can be based on a previous successful or sold listing of related product from a different user. The data can be used to make a subsequent recommendation to the user.

According to an embodiment, a method can comprise receiving, by a hardware processor of a service provider, information from a user about a product for listing with a service provider. A recommendation can be presented, electronically by the processor, to the user for revising the information. A determination can be made, by the processor, whether or not the user implemented the recommendation. The determination can be used to enhance the dynamic listing system, such as by evaluating and revising recommendations, as discussed herein.

According to an embodiment, data can be stored in a non-transitory memory. The data can correspond to whether or not the user implemented the recommendation. Thus, a record can be maintained regard what recommendations and/or what type of recommendations the user has implemented. This record can be used to determine the likelihood of the user implementing future recommendations and can thus be used to determine whether or not such future recommendations should be present to the user. In this manner, only recommendations that the user is likely to implement can be presented to the user.

The method can comprise receiving revised information for the product. The product can be listed on behalf of the user based on the revised information. The one or more processors can determine what recommendation to make for the user based on user actions from previous recommendations, listing information for a related product, and the type of product. The information can comprise a written description, a photo, a UPC code, and a price, for example. The recommendation can be to revise, e.g., amend or add, a written description, a photo, a UPC code, and/or a price, for example. The recommendation can be based on a previous successful or sold listing of related product from a different user. The data can be used to make a subsequent recommendation to the user.

According to an embodiment, highly specific, personalized, actionable, and trustworthy listing improvement recommendations for enhancing online listings are provided to online users. The recommendations can be sufficiently specific that ambiguity related thereto is substantially mitigated or eliminated, thus making the required action to be taken by the user clear, easy to understand, and readily implementable. The listing can be provided to or displayed for the user with selected or all of the recommendations implemented, so that the user can see exactly how the recommendations affect the listing.

A measure of the increased effectiveness of the listing due to implementation of selected or all of the recommendations can be provided to the user. The measure of the increased effectiveness can be based, at least in part, upon increased sells from such implementation. The increased sells can be projected based upon, at least in part, the historic implementation of the same or similar recommendations. That is, past implementation of recommendations can be used, at least in part, to predict the impact of future implementation of recommendations.

According to an embodiment, the recommendations can be specifically tailored with respect to the listing, the user, the online merchant, auction website, or commerce website, the time period or season, the product, the type of product, and/or any other desired factor. The recommendations can be for the user to take actions that the user is capable of taking, e.g., actions that can be easy to taken by the user. The recommendations can merely require the user's authorization such that the actions can be automatically performed, can be low cost or no cost, and can require little or none of the user's time (such as other than for authorization to implement) or other scarce resources. The recommendations can be based upon experience, such that enhanced results, e.g., better sales, are likely. Such experience can be determined by the analysis of historically sales and listing records, for example.

According to an embodiment, a set of tools can make it easy, e.g., trivially easy, for the user to implement recommendations. The user can prearrange for some recommendations to be implemented automatically, such as merely with the user's acknowledgement or authorization. The user can prearrange for some or all recommendations to be implemented automatically, such as without the user's acknowledgement or authorization. The user can prearrange for some or all recommendations to be implemented automatically without any involvement of the user. Use prearrangement can be done, for example, during a setup process, substantially in real time, or at any other time. In any event, the user can be notified when such recommendations have been implemented.

For example, the user can prearrange for selected recommendations or types of recommendations to be implemented automatically, without the intervention of the user during the setup process. The user can prearrange for other recommendation or types of recommendations to be implemented only with the user's approval, such as substantially real-time. The user can make or change how recommendations or types of recommendations are to be implemented substantially in real-time.

An efficient, simple, and effective graphic user interface (GUI) can facilitate the easy implementation of recommendations, such as those recommendations that require some amount of user input or authorization. Thus, users can be provided with an easy to use mechanism for implementing the recommendations. Changes to the listing due to implementation of recommendations can be view substantially in real-time. Changes to the listing that would result from implementation of recommendations can be previewed prior to implementation, if desired.

According to an embodiment, a substantial portion, e.g., all, of the analysis required to define and implement the recommendation can be done by the dynamic listing recommendation system. Such analysis can be custom tailored for a specific user and can thus be consistent with the user's buyer requirements. Such analysis can consider all available information regarding the user, prospective buyers and the product, as well as other factors such as the season, any geographic considerations, the online merchant or auction website, and any other relevant factors.

According to an embodiment, users can be told exactly what to do with their listings. Such recommendations can be provide in real-time, such as while a user is in the process of making a new online listing. Such recommendations can be provided at a later time, e.g., after the listing has be made, to facilitate the revision of an existing listing. Such recommendations can be provided after a listed has been removed (such as after a sale has been made or after the listing time has expired) to show how the listing may have been done in a better manner. Such recommendations can be provided at any desired time. Such post listing recommendation can provide ways for the user to enhance sales in the future, such as by more quickly selling products.

Feedback can be provided by potential customers or other regarding how the listing can be enhanced. Such feedback can be used to make and/or modify the recommendations to the user. A database of such feedback can be created. The database can be modified as new feedback is provided. The database can be analyzed to determine what changes or types of changes to listings are most often suggested by such feedback. The database can be analyzed to with respect to resulting sales to determine an effectiveness of changes or types of changes.

Listing quality can have various dimensions, characteristics, or features. When users list products with an online auction website, the users need to provide product details or information, provide one or more pictures, and specify the business policies, e.g., shipping and returns, and payment policies. The quality of a listing can be determined, at least in part, by the quality of the product information, and the quality of the picture(s), and quality of the service levels offered by the user.

More particularly, examples of factors affecting listing quality can include listing completeness, recommended/required item or product specifics adoption, listing in the correct category, listing against the right catalog product that will inherit the most accurate product information from the online auction website catalog, listing multi stock keeping unit (SKU) variations as on a multi SKU listing instead of on a plurality of single variation listings, picture(s), recommended number of images, recommended image size, recommended image quality, image brightness, graffiti, image border, image foreground to background (front-to-back) ratio, user business policies, service levels such as return policy and handling time that buyers expect, shipping (providing fast shipping that buyers expect), and pricing guidance.

According to an embodiment, the dynamic listing recommendation system can monitor substantially all product listing events. For example, dynamic listing recommendation system can monitor new listing creation, product revision, product sale, product end, product suspended and any other relevant events. The dynamic listing recommendation system can process, e.g., monitor, a listing any time the listing is modified.

According to an embodiment, the dynamic listing recommendation system can analyze the factors regarding listing quality. As a result of this analysis, the dynamic listing recommendation system can determine what recommendations to make in order to improve the quality of a listing. The dynamic listing recommendation system can communicate recommendations to the user regarding what to do to enhance the quality of the listing.

According to an embodiment, the dynamic listing recommendation system can determine what factors are important, what values to specify regarding such factors, the quality of pictures in the listing, and what service levels buyers expect. The dynamic listing recommendation system can use such information to provide the user with recommendations to improve listing quality.

After generating the listing improvement recommendations, the recommendations can be provided to the user. The user can then decide which, if any of the recommendations are to be implemented. Alternatively, some or all of the recommendations can be automatically implemented. Automatically implemented recommendations can be reported to the user, such as prior to, during, or after implementation.

According to an embodiment, the recommendations can also be stored, such as in a recommendation database. The recommendation database can serve the recommendations to any client application requesting for the recommendation. For example, the recommendation database can serve recommendations to one or more applications that can implement the recommendations.

The recommendation database can serve recommendations to one or more applications that can use information stored in the recommendation database to determine an effectiveness of such recommendations. For example, the application can analyze recommendation and sales information to determine which recommendations result in improved sales.

According to an embodiment, the dynamic listing recommendation system can reprocess the listing at any time, such as when the listing is modified. Thus, the recommendations stored in the recommendation database can be kept up to date and fresh.

An embodiment can also process scratch listings, e.g., listings that are in the process of creation or revision. Further, text blobs in Extensible Markup Language (XML) or JavaScript Object Notation (JSON) format containing listing information can be processed and recommendations can be generated substantially in real time regarding such listings or listing information.

According to an embodiment, client applications such as listing creation tools and listing management tools can communicate with the dynamic listing recommendation system. For example, client applications such as listing creation tools and listing management tools can communicate with the dynamic listing recommendation system to request that recommendations be provided to the user, such as while the user is creating the listing or revising an existing listing.

An embodiment can send a summary of recommendations to the user. The summary can contain information such as how many listings need improvement and what type of improvement is needed. Such summary information can be used by the user to determine how much has to be done to the user's listings, what has to be done to the user's listings, and what can be done in the future to provide better listings.

When a recommendation includes a need for further information, the dynamic listing recommendation system can provide potential sources of the information to the user. In this manner, the user can more readily obtain the needed information.

The recommendations and/or summary information can be sent via email or any other desired means, e.g., smart phone app notifications, Multimedia Messaging Service (MMS) or Short Message Service (SMS) text messaging. The user can designate what method or methods are to be used to send such information to the user, such as during a setup process for the dynamic listing recommendation system.

An embodiment can comprise a service and a framework. An embodiment can have a plurality of services. The services can be guidance providers. Different guidance providers can be used for different aspects of a listing. Thus, a plurality of different guidance providers can be used. Only relevant guidance providers need to be used for a particular listing. For example, guidance providers related to the use of graphics need not be used for listings without graphics. A guidance provider can be plugged into the dynamic listing recommendation system and can analyze the corresponding part of the listing.

Examples of guidance providers can include an item or product specifics guidance provider service, an UPC guidance provider service, a category guidance provider service, a product guidance provider service, a picture guidance provider service, a multi SKU guidance provider service, a listing standards guidance provider service, a shipping guidance provider service, a pricing guidance provider service, a guidance personalization service, and a guidance prioritization service.

Each such guidance provider can be a service that can be plugged into the dynamic listing recommendation system. Each such guidance provider can process the listing and determine whether or not the listing meets the recommended quality levels for the corresponding dimension.

For example, the product or item specifics guidance provider can examine the listing to see whether or not the listing has all of the recommended item specifics information filled in. If all of the recommended item specifics information is not filled in, then the item processor can process the title and description of the product to extract or otherwise obtain (such as from a database and/or the Internet) the relevant information for the user and can prefill the information for the user using values based on what the user has already entered in the title and description.

Recommendations provided by the dynamic listing recommendation system can be personalized. For example, an embodiment can understand, e.g., recognize, the context of the listing and the user and can generate personalized listing improvement recommendations based upon this information.

The context for personalization can be based on the particular listing site on which the user has listed the product, the listing category, the listed product, the user segment (e.g., business, consumer, entrepreneur, merchant, large merchant, etc.), the user performance level (e.g., top rated, above standard, etc.), and user behavior data (the user's past interaction when similar recommendations were provided).

For example, the general recommendation for most users would be to provide one day handling time. However, if a particular user has provided one day handling time in the past, but has consistently missed the deadlines and thus created bad buyer experience by setting unmet expectations, then an embodiment can learn from such past behavior of the user. The embodiment can recommend a different, more readily achievable goal, such as a three day handling time for the user. Thus, an embodiment can make recommendations based upon past experience with a user. Further, an embodiment can make recommendation based upon any other past experience, such as with a group of users, with suppliers to the users, with customers, with delivery services, and the like.

An embodiment can create user clusters based on user data. For example, transactional, demographic, behavioral, and/or performance data can be used to define such user clusters. The dynamic listing recommendations can take into account any unique characteristics of such clusters before making a recommendation.

As discussed above, an embodiment can comprise a plurality of services, which can be guidance providers. Each of the guidance provider services can provide recommendations for a listing based on what they have analyzed independently. Thus, there is a possibility that two or more guidance provider services might return conflicting recommendations. According to an embodiment, at least one service will know how to resolve such conflicts. At least one service, e.g., a conflict resolution service, can programmatically accommodate each of the recommendations with respect to each other's recommendation, even though the recommendations are provided by different guidance provider services. The conflict resolution service can prioritize the recommendations in the order of importance for the user. Conflicting recommendation of lessor importance can be abandoned in favor of conflicting recommendations of greater importance. The user can establish priorities. An administrator can establish priorities. The priorities can be established, by a person or a computer, using historic data.

According to an embodiment, a learning and feedback loop can be provided. The feedback loop can learn each time a recommendation is made and can potentially make better recommendations in the future based upon such learning from earlier recommendations. When a recommendation is made to the user, the user can take action, such as to implement the recommendation. The user can explicitly provide feedback about the accuracy and action-ability of the recommendation. The user can simply ignore the recommendation. The dynamic listing recommendation system can monitor whether or not the user implements recommendation and can monitor the effectiveness of such implementation. In this manner, closed loop feedback can be provided.

According to an embodiment, learning can have three substantial aspects, e.g., action-ability learning, active learning, and passive learning. Each aspect can be used to facilitate closed loop control of the dynamic recommendation listing system. Action-ability learning can occur based upon whether or not the user implements a recommendation. Further, action-ability learning can be based upon any modification may to a recommendation by the user or by another.

Active learning can occur when the dynamic listing recommendation system learns about the action-ability of the recommendation through the active feedback that the user provides. For example, such active feedback can include an instruction not to provide a particular recommendation again, not to ask for particular information again, or the like.

The dynamic listing recommendation system can learn about the accuracy of the recommendation through the active feedback provided by the user. For example, if the user's feedback indicates that the recommendation is not accurate, then the dynamic listing recommendation system can halt further use of that particular recommendation, at least in the same particular circumstances, until further analysis has been performed regarding the recommendation.

Passive learning can occur when the dynamic listing recommendation system learns through passive inference that user has not taken action on the recommendation provided by the dynamic listing recommendation system despite making the recommendation. For example, if the user has been shown a certain recommendation a predetermined number of times and the user has never implemented the recommendation, then the dynamic listing recommendation system can infer that this recommendation is probably not actionable or interesting to the user. The dynamic listing recommendation system can deprioritize the recommendation and/or give one or more other recommendations higher priority.

When the user implements the recommendation, the dynamic listing recommendation system can capture and store, such as in a database, the adopted value. The adopted value can be the same value that was recommended or can be some other value, such as a value input by the user. An embodiment enables the infrastructure to capture the user adopted value, and pass it back to the guidance provider services to improve their training data, and improve their algorithms to make better recommendations.

Real time guidance in the listing flow can be provided. When the user creates a new listing, relists an existing listing, sells a similar product to the one he already has a listing for, or revises an existing live listing, then the dynamic listing recommendation system can communicate the necessary payload and the product information as entered by the user, and can provide recommendations. The dynamic listing recommendation system scan or process the listings and can provide listing improvement recommendations substantially in real time.

At the start of a create/revise/relist/sell similar listing flow, a listing app can call the dynamic listing recommendation system with the necessary payload and can return all the recommendations up front so that the listing app can display what the user is expected to enter and which fields are important to fill in. Using this information from the dynamic listing recommendation system, the listing app can provide different visual treatment to those fields that the dynamic listing recommendation system recommends to be filled in.

Product or item specifics guidance can be provided by the dynamic listing recommendation system. As soon the user enters the product title, the listing app can call the dynamic listing recommendation system. The dynamic listing recommendation system can process product title, site, and category, and can identify whether the user has entered the required or recommended item specifics information for the listing.

The dynamic listing recommendation system can then send the product title, product description (when available), and listing category to entity extractor services that are plugged into the dynamic listing recommendation system. The entity extractor services can extract the concepts and return the item or product specific name value pairs that likely describe the product, value being extracted from the product title.

For example, the user can enter the title as Eureka Boss 3670G, Vacuum Cleaner, canister, bag, yellow. Then, the entity extractor services can extract the concepts and return the recommended name values such as brand is Eureka, model is 3670G, type is canister, dirt, capture is bag, color is yellow. Thus, the dynamic listing recommendation system can parse, correlate, and/or process information so as to better use the information in the user's online listing.

The dynamic listing recommendation system can then perform a semantic validation of the item specifics names returned by extractor services against the valid names and values returned by a unified metadata services to remove any name value pairs that are not canonicalized by the extractor services. The semantically validated values can then returned to the listing app. The listing app can prefill the values for the user in the item specifics fields without the user needing to input the values again.

The user can either accept the values or correct the values by removing the recommended value and entering the user's own value. In either case, the user input value can be captured and stored in a database. The original input and the response from extractor services, e.g., the extracted value or the user entered value, along with other details can then fed back to the extractor services. In this manner, the dynamic listing recommendation system can learn and thereby improve the data and algorithms associated therewith.

Picture or image guidance can be provided. The dynamic listing recommendation system can process pictures and provide picture improvement recommendations. The picture improvement recommendations can include a recommended minimum number of images, a recommended number of images, a minimum image resolution, and a recommended image resolution.

The picture improvement recommendations can include recommendations regarding image graffiti, an image border, image brightness, an image contrast, image foreground to background ratio, image focus, and image views. The dynamic listing recommendation system can detect whether the image has user input text and/or graffiti and can recommend that the image be replaced, for example.

The dynamic listing recommendation system can detect whether the image has a user input border and can recommend that the image be replaced or that border cropped out, for example. The dynamic listing recommendation system can detect suboptimal brightness and contrast in image and can recommend that the brightness levels be improved to recommended levels, for example. The dynamic listing recommendation system can detect a suboptimal foreground-to-background ratio of the image and can recommend that the image be replaced or cropped to provide a recommended ratio, for example. The dynamic listing recommendation system can detect out of focus images and can recommend that such images be replaced, for example.

The dynamic listing recommendation system can analyze image views. This can be done via user input metadata regarding the view of the object. For example, the metadata can include tags such as front view, back view, top view, bottom view, left side view, right side view, and/or inside view. Depending upon the inventory, the dynamic listing recommendation system can recommend what views are important for that product, and can recommend that the user upload photos representing the views that are recommended for that product.

The picture guidance can have two major parts, i.e., a generating metadata part and a generating recommendations part. Metadata can be generated regarding the image quality. An image digester service can process raw images and generate raw metadata regarding the image. The raw metadata can include information regarding image resolution, brightness, whether graffiti is present or not, and whether there is a border or not.

The dynamic listing recommendations system can generate recommendations to improve an image. The recommendations can be based on the site, category, product, and the user, and the buyer demand data, which can be the settings that are most important for buyers. For example, in image view recommendation, in case of solid objects such as phone, inside view is not important but for hand bags, inside view is critical for buyers to make a purchase decision. The dynamic listing recommendations system can use information regarding the product to provide appropriate recommendations for the product.

During a picture upload process in the create/revise/relist/sell similar listing flow, the listing app can call an embodiment with the picture uniform resource locator (URL) of the picture uploaded to the picture services and storage. The dynamic listing recommendation system can then fetch the raw metadata of the picture from the image. A service can evaluate the picture within the context of the listing (such as site, category, user, and buyer demand data), and can then generate the picture guidance, and returns the recommendations to the listing app.

Recommendations can be time based, location base, product based, user based, or can be based upon any other desired information or criteria. For example, recommendations can be based upon the time of year or season. Thus, a recommendation for a listing for a child's bicycle near Christmas can include a holly or other Christmas decoration for a border (such as a photograph border or a text box border) whereas a recommendation for a listing for the same bicycle in the middle of the summer can include a solid black border. As a further example, a recommendation for a listing for a fishing rod targeting buyers in Alaska and Canada can show a fishing scene on a lake in a pine forest whereas a recommendation for a listing for the a fishing rod targeting buyers in Hawaii can include a fishing scene on the ocean. In this manner, listings can be customized.

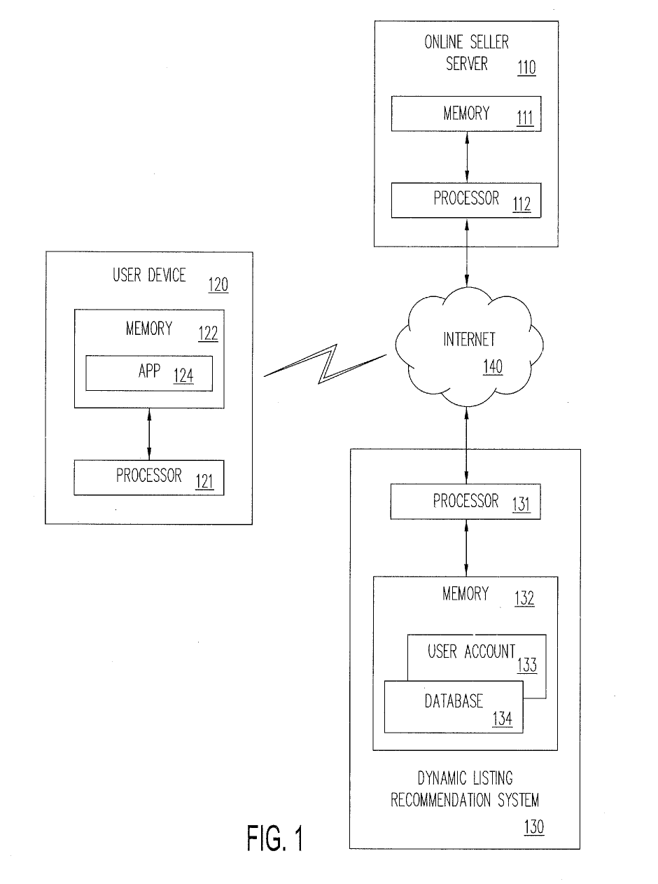

FIG. 1 is a block diagram of a system for providing dynamic listing recommendations according to an embodiment. The system can include an online seller server 110, a user device 120, and/or a dynamic listing recommendation system server 130. The online seller server 110 and the dynamic listing recommendation system server 130 can be the same or different servers. The dynamic listing recommendation system server 130 can be a server of a seller (such as an online auction or commerce service), a payment provider, a dedicated listing recommendation service, or any other entity. In any event, the online seller can implement or use the dynamic listing recommendation system. The functions discussed herein can be split and/or shared among the online seller server 110, the user device 120, and/or the dynamic listing recommendation system server 130, as desired.

The online seller server 110 can be used to facilitate online auction sales or other online sales, for example. The online seller server 110 can be a server of an online auction or commerce website, such as eBay, for example. The online seller server 110 can include a memory 111 and a processor 112. The online seller server 110 can be used for facilitating online sells, auction and payment processing. The online seller server 110 can be used for any other purpose.

The user device 120 can be a computer of the user. The user device 120 can comprise a desktop computer or can comprise a mobile device such as cellular telephone, a smart telephone, a hand held computer, a laptop computer, a notebook computer, or a tablet computer, for example. The user device 120 can include a processor 121, and a memory 122.

The user device 120 can be used for posting listings on the online seller server 110. The user device 120 can be used for any other purpose, such as designing and modifying listings, facilitating financial accounting related to online sales, and the like.

An app 124 or other software can be stored in the memory 122 and executed by the processor 121. The app 124 can be used for designing listings, posting listing, maintaining listings, tracking sales from listings, receiving recommendations regarding listings, and/or modifying listings (such as per the recommendations). The app 124 can be a mobile app.

The dynamic listing recommendation server 130 can comprise a server of a payment provider, such as Paypal, Inc. Thus, the dynamic listing recommendation server 130 can facilitate listing of items to be sold via online auctions or other online sellers, can facilitate online auctions, and can facilitate payment for products purchase via online auctions. The dynamic listing recommendation server 130 can be used for other purposes.

The dynamic listing recommendation server 130 can be a single server or can be a plurality of servers. The dynamic listing recommendation server 130 can include one or more processors 131 and one or more memories 132. The memory 132 can be a memory of the dynamic listing recommendation server 130 or a memory that is associated with the server 130. The memory 132 can be a distributed memory. The memory 132 can store a user account 133 and a database 134. The user account 133 can store user listing information such as information related to the user listings, recommendations, implemented recommendations, sales, and the like. The database 134 can comprise and/or define various ones of the databases discussed herein or combinations thereof.

Generally, the online seller server 110, the user device 120, and the dynamic listing recommendation system server 130 can perform functions discussed herein. That is, at least to some extent, a function that is discussed herein as being performed via one of these devices can be performed by a different one of these devices, by a combination of these devices, and/or by other devices.

The online seller server 110, the user device 120, and the dynamic listing recommendation server 130 can communicate with one another via a network, such as the Internet 140. The online seller server 110, the user device 120, and the dynamic listing recommendation server 130 can communicate with one another via one or more networks, such as local area networks (LANs), wide area networks (WANs), cellular telephone networks, and the like. The online seller server 110, the user device 120, the social network 150, and the dynamic listing recommendation server 130 can communicate with one another, at least partially, via one or more near field communications (NFC) methods or other short range communications methods, such as infrared (IR), Bluetooth, WiFi, and WiMax.

FIG. 1 illustrates an exemplary embodiment of a network-based system for implementing one or more processes described herein. As shown, the network-based system may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or another suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

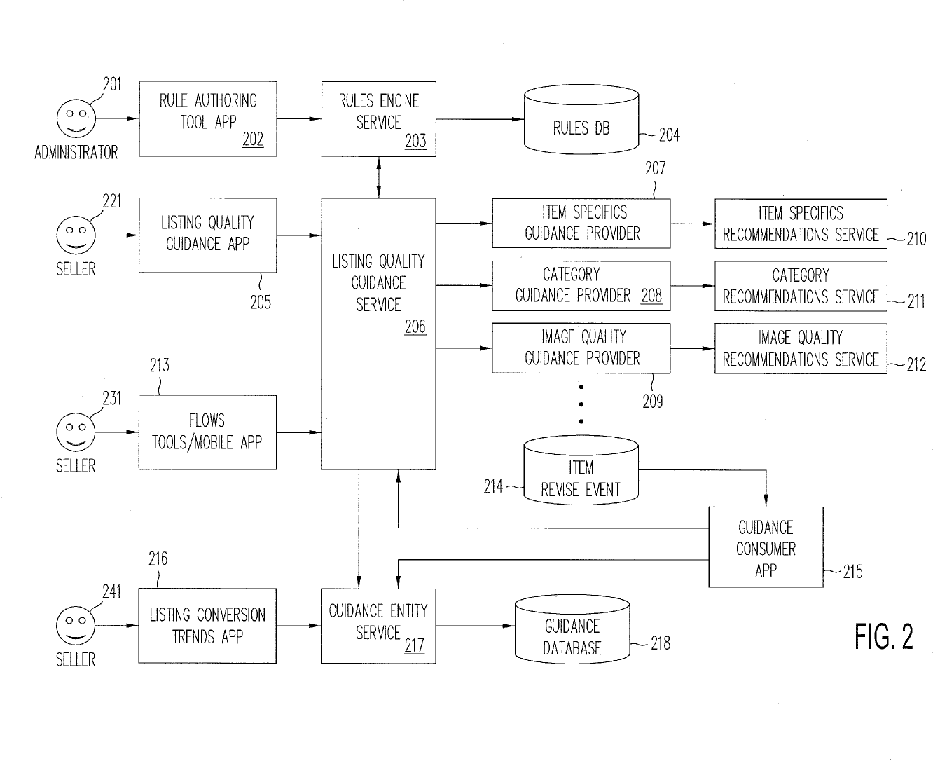

FIG. 2 is a block diagram of an architecture for the system for providing dynamic listing recommendations, according to an embodiment. An administrator 201 or the like can cooperate with a rule authoring tool app 202 to develop dynamic listing recommendation system rules. Rule authoring tool 202 can be an app of memory 122 of user device 120, for example. Rule authoring tool 202 can be defined by app 124. Rule authoring tool 202 can be defined by any other program and/or can be stores and used on any desired device or combination of devices.

The rules can be run on rules engine service 203 to analyze listings to facilitate the making of recommendations for improving the listings. The rules can be stored in rules database 204 and retrieved by the rules engine service 203, as needed. For example, the administrator 201 can conceive of a rule and the authoring tool app 202 can function as a program language development tool to help the administrator 201 convert the conceived rule into programming language that can be used by the rules engine service 203. The rules engine 203 can be run on processor 112, for example. The rules database can be stored in memory 111, for example.

The rules engine service 203 can apply the rules to listings. As a result of applying the rules, the rules engine service 203 can make recommendations when violations of the rules are found in a listing. For example, if a poor photograph, e.g., an out of focus photograph, is found in a list, then a recommendation that the out of focus photograph be replace with a better photograph can be provided.

A first seller 221 can use listing quality guidance 205 to develop a listing. Listing quality guidance app 205 can be an app of memory 122 of user device 120. Listing quality guidance app 205 can be defined by app 124, for example. Listing quality guidance service 206 can cooperate with rules engine 203 to facilitate the application of the rules to a listing, as discussed herein.

Item specifics guidance provider 207 can cooperate with the listing quality guidance service 206 to provide item specific recommendations to item specifics service 210. The item specifics guidance provider 207 can use the listing quality guidance service 206 to apply rules via rules engine 203 that relate to item specifics to facilitate providing of the item specific recommendations to items specifics recommendations service 210. Item specifics can be listing information or details that depend upon the specific product that is listed. Thus, item specifics can vary from product to product. For example, item specifics can include the name, model, and specifications of the product.

Category guidance provider 208 can cooperate with the listing quality guidance service 206 to provide category recommendations to category service 211. The category guidance provider 208 can use the listing quality guidance service 206 to apply rules via rules engine 203 that relate to item categories to facilitate providing of the category recommendations to category recommendations service 211. Categories can be listing information that depends upon the type or category of product that is listed. Categories can be defined in any desired manner. Generally, categories can be defined in a manner such that rules can be based thereon. That is each category can have a common subset of rules. For example, categories can include sporting goods, computers, and home entertainment. A subset of the rules relating to sporting goods can require more pictures than for computers while a subset of the rules relating to computers can require more specifications that for sporting goods, for example.

Image quality guidance provider 209 can cooperate with the listing quality guidance service 206 to provide image quality recommendations to image quality recommendations service 212. The image quality guidance provider 209 can use the listing quality guidance service 206 to apply rules via rules engine 203 that relate to image quality to facilitate providing of the image quality recommendations to image quality recommendation service 212. Image quality can include various aspects of an image such as focus, color versus black and white, image size, aspect ratio, number of images, use of boarders, used of text in the image, for example.

The listing quality guidance service 206 can facilitate application of rules to listings, such as by cooperating with rules engine 203. The listing quality guidance service 206 can cooperate with rules engine 203 to facilitate the application of the rules to a listing. The listing quality guidance service 206 can cooperate with listing quality guidance app 205 to provide listing quality guidance to the first user 221, such as when the first user 221 is making a new listing or modifying an existing listing. The listing quality guidance service 206 can cooperate with flows/tools/mobile app 213 to monitor information flows of information between the second user 231 and the dynamic listing recommendation system. Such information flows can occur during the initial making of the listing, during any modification of the listing, and/or during any routine actions by the second user 221 (such as monitoring the listing).

Guidance consumer 215 can cooperate with listing quality guidance 206 and guidance entity 217 to facilitate the revision of listings, such as according to recommendations provided by the dynamic listing recommendation system. A database of such revisions can be maintained in revise event database 214. The database of revisions can be used to facilitate closed loop feedback control, as discussed herein.

Listing quality guidance service 206 can cooperate with listing conversion trends 216 to define listing conversion trends and to provide guidance to the third user 241 base upon listing conversion trends. Listing conversion trends can be trends associated with conversion (purchases), such as trends that can be associated with the quality of the listing and/or trends that can be associated with modification made to the listing due to recommendations provided by the dynamic listing recommendation system.

A guidance entity service 217 can cooperate with the listing conversion trends 216 to determine what guidance is to be provided based, at least in part, upon listing conversion trends. Such guidance can also be based, at least in part, upon the rules. Information regarding such guidance can be stored in guidance database 218.

The second seller 231 can use flows/tools/mobile 213 to create and/or modify the listing. The flows/tools/mobile 213 can be an app, such as an app of memory 122 of user device 120. The flows/tools/mobile 213 can be defined by app 124, for example. The flows/tools/mobile 213 can be an app that provides the interface and tools required by the user to construct and position the components of the listing, so as to define the listing. Flows/tools/mobile 213 can cooperate with listing quality guidance 206 to assure that the listing is constructed in a desired, e.g., higher quality, manner.

A third seller 221 can use listing conversion tools 216 to convert listing. Listing conversion tools 216 can be an app, such as an app of memory 122 of user device 120. Listing conversion tools 216 can be defined by app 124. Listing conversion tools 216 can cooperate with listing quality guidance 206 to convert listing from one format to another. For example, conversion tools 216 can convert a listing from ASCII text to HTML or the like.

The first seller 221, second seller 231, and third seller 241 can be the same seller or can be different sellers. The listing quality guidance service 206 can cooperate with the rules engine.

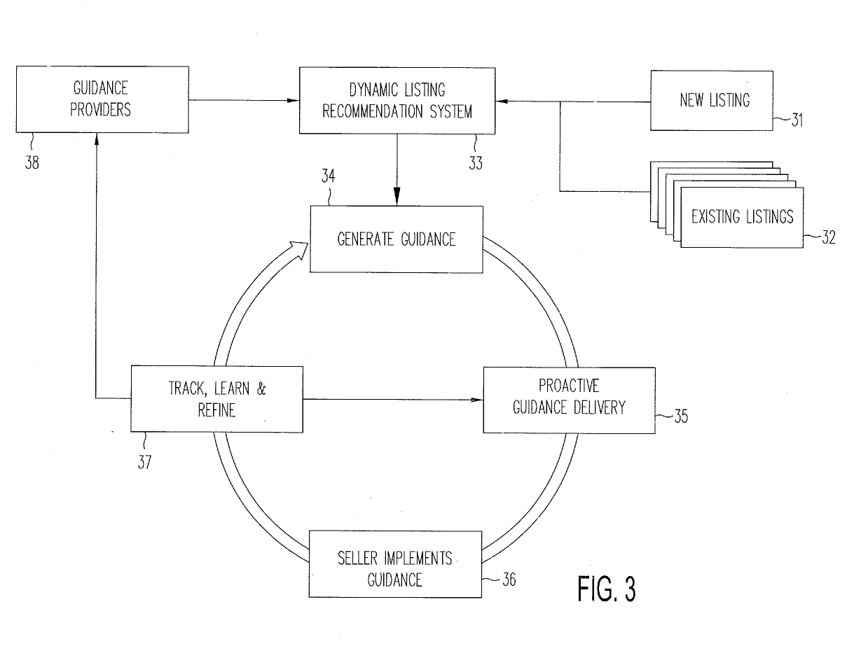

FIG. 3 is a flow chart of the method for providing dynamic listing recommendations, according to an embodiment. A new listing 31 can be made by the user. The new listing, as well as any existing listings 32, can be analyzed by the dynamic listing recommendation system 33. The analysis can be performed according to rules, as described herein.

The dynamic listing recommendation system 33 can generate guidance, as shown in block 34. The guidance can be communicated, such as via text messaging or email, to facilitate proactive guidance deliver, as shown in block 35. The sell can implement the guidance, as shown in block 36.

The dynamic listing recommendation system 33 can track, learn, and refine, as shown in block 37. More particularly, the dynamic listing recommendation system 33 can track the performance of the listing, such as measured by the number of views of the listing, the time spend by potential customers viewing the listing, and the conversion rate for the listing. From such tracking, the dynamic listing recommendation system 33 can learn what rules tend to work and what rules do not. Rules can be refined or modified based, at least in part, upon such learning. The modified rules can be used by guidance providers 38, such as to facilitate the proactive guidance delivery, as shown in block 35.

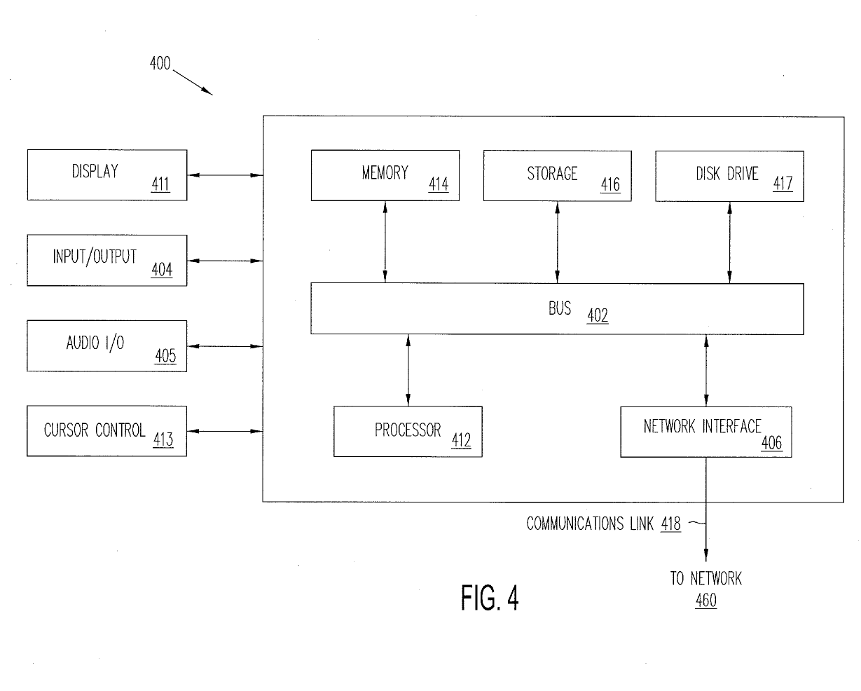

FIG. 4 is a block diagram of a computer system 400 suitable for implementing one or more embodiments of the present disclosure. In various implementations, a terminal may comprise a computing device (e.g., a personal computer, laptop, smart phone, tablet, PDA, Bluetooth device, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows. For example, the computer system 400 or portions thereof can define or partially define the online seller server 110, the user device 120, and/or the dynamic listing recommendation system 130.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as a user device, a merchant server, or a payment provider server via network 460. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable and executable media include, for example, floppy disk, flexible disk, hard disk, magnetic tape, any other magnetic medium, CD-ROM, any other optical medium, punch cards, paper tape, any other physical medium with patterns of holes, RAM, ROM, E2PROM, FLASH-EPROM, any other memory chip or cartridge, carrier wave, or any other medium from which a computer is adapted to read.

In various embodiments, execution of instruction sequences for practicing the invention may be performed by a computer system. In various other embodiments, a plurality of computer systems coupled by a communication link (e.g., LAN, WLAN, PTSN, or various other wired or wireless networks) may perform instruction sequences to practice the invention in coordination with one another. Modules described herein can be embodied in one or more computer readable media or be in communication with one or more processors to execute or process the steps described herein.

A computer system may transmit and receive messages, data, information and instructions, including one or more programs (i.e., application code) through a communication link and a communication interface. Received program code may be executed by a processor as received and/or stored in a disk drive component or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa—for example, a virtual Secure Element (vSE) implementation or a logical hardware implementation.

Software, in accordance with the present disclosure, such as program code and/or data, may be stored on one or more computer readable and executable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The one or more memories and/or the one or more processors can be one or more memories and/or the one or more processors of the online seller server 110, the user device 120, the dynamic listing recommendation server 130, and/or any other device or system. Memories and/or processors from any number of devices, systems, and entities can cooperate to perform the dynamic listing recommendation method disclosed herein.

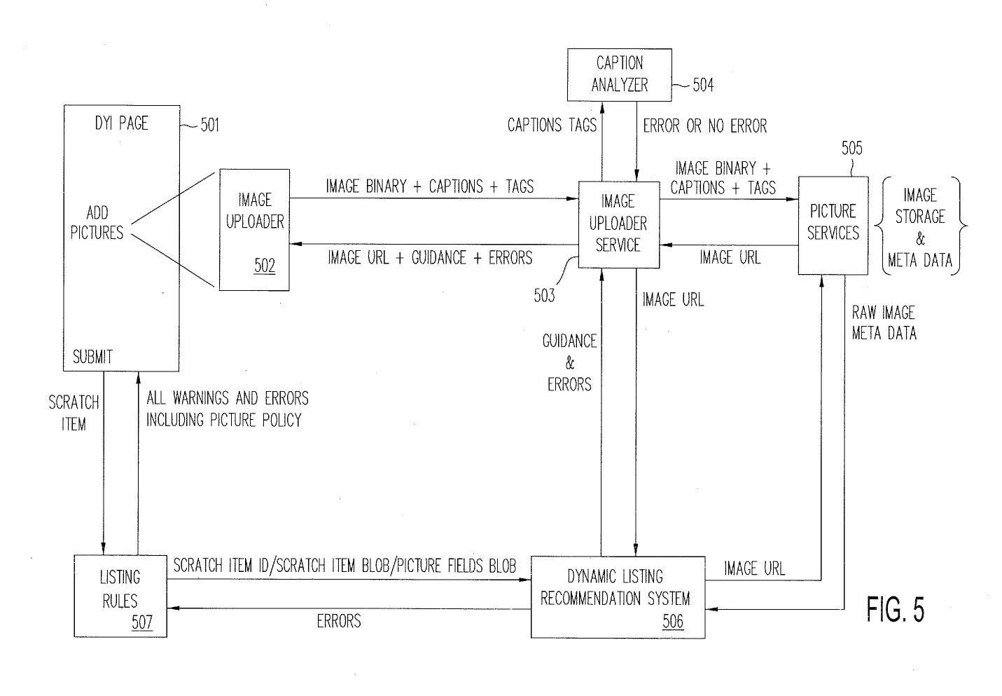

FIG. 5 is a flow chart of a method for providing picture guidance according to the method for dynamic listing recommendations, according to an embodiment. A Describe Your Item (DYI) listing or page 501 can be made by a user. As part of the DYI page 501, one or more images can be uploaded, such as to the online seller server 110. The images can be uploaded via an image uploader 502. The image uploader 502 can provided the images to an uploader service 503. The uploader 502 can be part of the app 124, for example. The uploader service 503 can be run by the online server 110.

The uploader service 503 can provide image information related to the images, such as captions, tags, and the like, to a caption analyzer 504. The caption analyzer 504 can analyze the image information and can provide indications of any errors determined to be therein to the uploader service 503. Any such errors can be communicated to the dynamic listing recommendation system 506 and then reported to the user according to the rules 507, as discussed herein. The image, along with any caption and tags, can be posted on the listing 505.

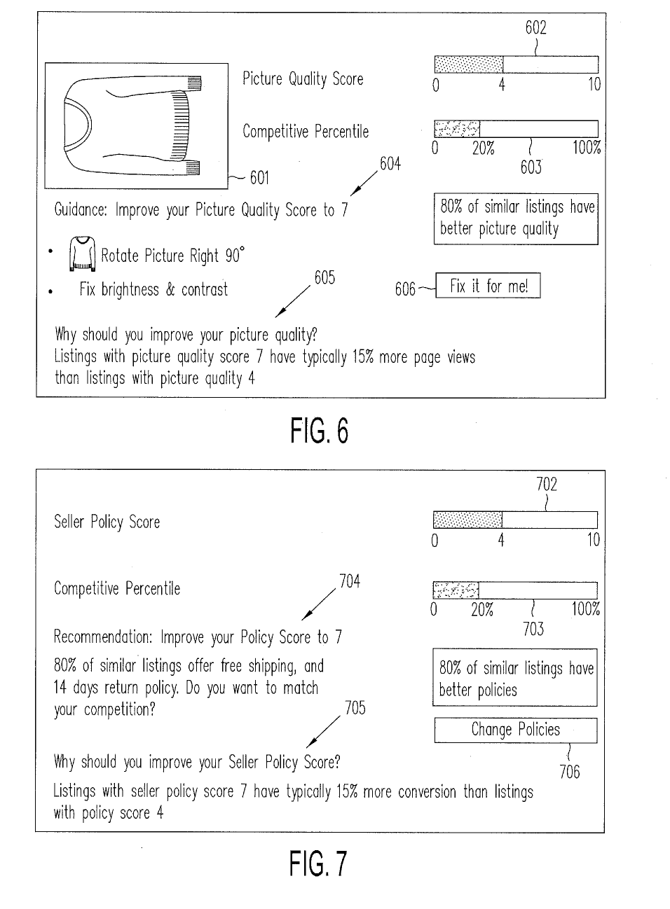

FIG. 6 is an example of a picture quality score provided to the user by the method for providing dynamic listing recommendations, according to an embodiment. The picture 601 can be shown. A picture quality score indicator 602 can provide an absolute indication of the determined quality of the picture. Similarly, a picture quality competitive percentile 603 can provide a relative indication of the picture quality, e.g., an indication of how the picture quality compares to that of other pictures, such as pictures in listings of other users. Recommendations or guidance 604 can be provided for improving the picture quality. Reasons 605 for implementing the recommendations can be provided. Clicking on a fix button 606 can cause the dynamic listing recommendation system to fix at least some of the problems with the picture, so as to improve the picture quality.

FIG. 7 is an example of a seller policy score provided to the user by the method for providing dynamic listing recommendations, according to an embodiment. The seller policy score can provide the seller with a determination of how effective the seller's policies have been in providing conversion. A seller policy score indicator 702 can provide an absolute indication of the seller's policies. Similarly, a seller policy competitive percentile 703 can provide a relative indication of the seller's policies, e.g., an indication of how the seller's policies compare to those of other sellers, such as other users of the same online seller or website. Recommendations or guidance 704 can be provided for improving the seller's policies. Reasons 705 for implementing the recommendations can be provided. Clicking on a fix button 706 can cause the dynamic listing recommendation system to fix at least some of the problems with the seller's policies and thereby attempt to improve the user's conversion rate.

Other types of listing improvement recommendations can include miscategorization recommendations and product recommendations. Miscategorization recommendations can be provided by the dynamic listing recommendation system by evaluating the listings to determine if they are in a recommended category, e.g., the top recommended categories. If not, then the dynamic listing recommendation system can provide a recommendation to change the category to such a category, e.g., one of the recommended categories.

The dynamic listing recommendation system can evaluate listings to determine whether they are listing against a recommended product, e.g., an eBay recommended product. All listings that are not listed against a product can also be evaluated. For example, the dynamic listing recommendation system can call a match product service with the product title so as to obtain product recommendations along with confidence scores. If there are any matching products with high confidence score, the dynamic listing recommendation system can generate recommendations with product IDs as recommended products for the listing.

Shipping considerations can include a recommendation, such as the eBay Fast N Free recommendation. For example, in order to be eligible for the Fast N Free Shipping promotion, a user can offer a max of one, two, three, or four day handling plus shipping time combined, along with free shipping. The shipping time and any other such parameters can be user configurable. The dynamic listing recommendation system can evaluate whether the listings meet this criteria, and generate recommendations on the recommended values for shipping and handling time in order for the listings to become eligible for the Fast N Free promotion.

Shipping considerations can include recommendations regarding shipping locations. For example, shipping recommendation can include cross border shipping recommendations. An embodiment can evaluate the type of inventory that the user is listing, and understand from past transactions including search volume, and purchases, the demographic of the buyers including buyer location for each unique inventory or a group of inventory (loosely based on listing category). Accordingly, whenever a user lists a product, or already has an existing product, but has not offered shipping services to locations where most buyers are located, then an embodiment can generate recommendation for providing shipping options to those locations in which large percentage of buyers for this inventory is located.

Recommendations regarding pricing can be provided. The dynamic listing recommendation system can evaluate the listing context and generate pricing recommendations for the user to offer the most competitive price. The pricing recommendations can be based on recommendations generated by the dynamic pricing service that is plugged into the dynamic listing recommendation system.

Re-pricing rule recommendations can be provided. Users are able to set re-pricing rules for their listings to programmatically match market prices without manual intervention based on one time re-pricing rule set for their listings. The dynamic listing recommendation system can evaluate all listings for which users have not set re-pricing rules, and generate recommendations to set the re-pricing rules for the listings.

A multi stock keeping unit (MSKU) recommendation can be provided. Users list both single variation listings, and multiple variation listings. However whenever user has listed/or is in the process of listing a single variation listing for a product for which a live listing exists for another variation, then The dynamic listing recommendation system will identify the two single variations, and recommend the user that the listing be listed as multiple variation (multi-SKU listing). This is done by plugging in MSKU detection service, and the actual listing compression is done using MSKU compression tool.

Post Listing Guidance can be provided. The dynamic listing recommendation system can evaluate all existing listings much as the same it can do for listings during real time flow. The dynamic listing recommendation system batch process the existing listings, and generates listing improvement recommendations and stores the recommendations in the guidance database, for serving to any client that ask for recommendations for any listing. The recommendations are regenerated and refreshed any time a listing is modified by any client for any reason, and recommendations are updated in the guidance database. This way, the recommendations generated are always fresh, at any given time.

The dynamic listing recommendation system can provide post listing guidance. The can have existing listings for which the dynamic listing recommendation system has generated listing improvement recommendations. The dynamic listing recommendation system can provide a summary count of listings that need updates for each type of recommendation (item specifics, top rated user services, picture etc.). The product ID, item ID, or listing ID of listings that have listing improvement recommendations for each type of recommendation can be provided.

After user has implemented the recommendations, upon request from client tools, evaluate a given listing/listing details blob (JSON or XML) on whether the listing is now meeting all the listing quality standards. This response from the dynamic listing recommendation system is used for generating confirmation messages on how many listings that the user worked with are now meeting the recommended standards. This post listing guidance can be for all the types of listing improvement recommendations.

According to an embodiment, a summary of listing improvement recommendations can be provided. A users can click on a link and can be presented with the listings that need updates, such as via a customized bulk edit tool.

Asynchronous pagination can be used to retrieve data from the dynamic listing recommendation system database. The dynamic listing recommendation system can generate recommendations for hundreds of millions of listings, for example. The guidance database can have over one billion rows, for example.

When the client makes a call to the dynamic listing recommendation system to fetch product IDs of products that have listing improvement recommendations for a given user, then the dynamic listing recommendation system can query the database and can fetch all of the product IDs. At this time, the dynamic listing recommendation system can place in the collection service, and return the appropriate product IDs per response. The database can have a first time data fetch limitation that cause a delay while to fetching the records for a user for the first time. This could be up to even 30,000 milliseconds in most cases. However, the dynamic listing recommendation system can return these products in less than 300 milliseconds. In order to accomplish this, the dynamic listing recommendation system uses asynchronous pagination. When a client calls the dynamic listing recommendation system to return the product IDs for a user who has many, e.g., 100,000, products that have listing improvement recommendations, the dynamic listing recommendation system can initiate the database operations to fetch the product IDs for the user. However, when the first batch, e.g., 5000, product IDs are fetched, the dynamic listing recommendation system can place the first batch of product IDs in collection service, return a portion, e.g., 2500, of the product IDs in the first page of response, and indicate to the client to make the next call to fetch the rest 2500 products. By the time the client makes the second call, the dynamic listing recommendation system is ready with all, e.g., the 100,000 listings.

Next, the user can implement the recommendations. Implementation of the recommendations can be done manually, with substantial user input. Implementation of the recommendations can be done automatically, with little or no user input.

Listings can be revised with the new values, and the dynamic listing recommendation system evaluates the new listing in real time, and provides confirmation message on how many of the listings that the user worked with, are now meeting the recommended standards.

The dynamic listing recommendation system can provide UPC/Product Guidance via the app 124. The use of structured data, such as for listings, can be important to the online seller. As catalog coverage increases, the existing listings that may not be listed against an existing catalog. For example, there may be GTC listings that were listed prior to the use of a catalog. As a further example, the user may have been unable to find the correct catalog, such as when an incorrect catalog recommendation has been made due to limited information in product title.

The dynamic listing recommendation system identifies listings that are missing item specifics, or UPC, and can provide catalogue recommendations. The dynamic listing recommendation system tell the users exactly how many listings are missing what structured data, e.g., product identifiers such as UPC/EAN/ISBN or required/recommended item specifics, and can provide a one click experience to load all those listings into the bulk edit tool, and update the listings in bulk.

The dynamic listing recommendation system mobile app 124 can present users with the list of their products that are missing product identifiers. Users can then simply scan their inventory, and the dynamic listing recommendation system can capture, via the scanned information, the structured data. Because the solution is through mobile app, the user can carry the mobile to warehouse to update, or some enterprising users might also scan the inventory from a retail store, especially when they are selling used products that have no box package or no barcode.

The dynamic listing recommendation system can also extend this work flow for multiple other use cases. For example, the dynamic listing recommendation system can identify all the listings that the user has sold but has not updated tracking information, and can provide the list to the user, and the user can scan their shipping labels to upload tracking information.

For example, the user can have a number, e.g., five, listings that the dynamic listing recommendation system has identified as missing product identifiers. The listings are not listing against a catalogue product as well. A listing completeness score and/or listing quality scores can be provided. When the dynamic listing recommendation system evaluates each part of the listing to see whether the listing has provided the recommended values/quality/standards or not, the dynamic listing recommendation system also calculates a completeness score for each of the recommendation provider. And the completeness score for each recommendation provider will be used to compute the completeness score for the listing, based on statistical models. This completeness score could well be represented in the form of a percentage score. Based on adoption of recommended listing quality levels of individual aspects of listing, such as item specifics, category, product, shipping, returns, picture quality, and MSKU adoption, an overall listing completeness score will be calculated that will be indicative of the quality of the listing.

For example a listing that has only one out of four recommended item specifics may have a item specifics completeness score of 25%. In top rated user services, the user may have provided only the recommended handling time, and not provided the recommended return policy, thus earning a score of 50%. Assuming that the listing is evaluated only for these two criteria, then overall listing completeness score could be the weighted average (0.25:0.75) of the individual scores at 43% complete.

The feedback loop can be closed. For example, users can be provided with analytics regarding what actions can be taken to improve their listing quality, or what actions they took that resulted in higher listing quality and how it relates to their sales/revenue/profit and other business metrics.

The one or more memories and one or more hardware processors can be part of the same device, e.g., server. The one or more memories and one or more hardware processors can be part of the different devices, e.g., servers. The one or more memories and one or more hardware processors can be co-located. The one or more memories and one or more hardware processors can be located in different places, e.g., different rooms, different buildings, different cities, or different states.

In implementation of the various embodiments, embodiments of the invention may comprise a personal computing device, such as a personal computer, laptop, PDA, cellular phone or other personal computing or communication devices. The payment provider system may comprise a network computing device, such as a server or a plurality of servers, computers, or processors, combined to define a computer system or network to provide the payment services provided by a payment provider system.

In this regard, a computer system may include a bus or other communication mechanism for communicating information, which interconnects subsystems and components, such as a processing component (e.g., processor, micro-controller, digital signal processor (DSP), etc.), a system memory component (e.g., RAM), a static storage component (e.g., ROM), a disk drive component (e.g., magnetic or optical), a network interface component (e.g., modem or Ethernet card), a display component (e.g., CRT or LCD), an input component (e.g., keyboard or keypad), and/or cursor control component (e.g., mouse or trackball). In one embodiment, a disk drive component may comprise a database having one or more disk drive components.

The computer system may perform specific operations by processor and executing one or more sequences of one or more instructions contained in a system memory component. Such instructions may be read into the system memory component from another computer readable medium, such as static storage component or disk drive component. In other embodiments, hard-wired circuitry may be used in place of or in combination with software instructions to implement the invention.

As used herein, the term “product” can include any product or service. Thus, the term “product” can refer to physical products, digital goods, services, or anything for which a user can make a payment, including charitable donations. A product can be any item or anything that can be sold. Examples of products include cellular telephones, concerts, meals, hotel rooms, automotive repair, haircuts, digital music, and books. The product can be a single product or a plurality of products. For example, the product can be a tube of toothpaste, a box of laundry detergent, three shirts, and a picture frame.

As used herein, the term “mobile device” can include any portable electronic device that can facilitate data communications, such as via a cellular network and/or the Internet. Examples of mobile devices include cellular telephones, smart phones, tablet computers, and laptop computers.

As used herein, the term “network” can include one or more local area networks (LANs) such as business networks, one or more wide area networks (WANs) such as the Internet, one or more cellular telephone networks, or any other type or combination of electronic or optical networks.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure. Having thus described various example embodiments of the disclosure, persons of ordinary skill in the art will recognize that changes may be made in form and detail without departing from the scope of the invention. Thus, the invention is limited only by the claims.

What is claimed is:

1. A system for facilitating a financial transaction over a network, the system comprising:
one or more memories storing user account information, wherein the user account information comprises listing information for a product listing associated with a user account; and
one or more hardware processors in communication with the one or more memories adapted to:
receive, from a user, product information for listing with a service provider;
present a recommendation to the user for revising the product information;
determine whether the user made the recommendation; and
store data corresponding to whether the user implemented the recommendation.

2. The system of claim 1, wherein the one or more hardware processors further receive revised information for the product and list the product on behalf of the user based on the revised information.

3. The system of claim 1, wherein the one or more hardware processors further determine what recommendation to make for the user based on at least one of a user action from a previous recommendation, listing information for a related product, and type of product.

4. The system of claim 1, wherein the information comprises a written description, a photo, a UPC code, service policies, and a price.

5. The system of claim 1, wherein the recommendation is to revise at least one of a written description, a photo, a UPC code, service policies, and a price.

6. The system of claim 1, wherein the recommendation is based on a previous listing of a related, sold product from a different user.

7. The system of claim 1, wherein the data is used to make a subsequent recommendation to the user.

8. A non-transitory machine-readable medium comprising a plurality of machine-readable instructions which when executed by one or more hardware processors of a server are adapted to cause the server to perform a method comprising:
receiving, from a user, information about a product for listing with a service provider;
presenting a recommendation to the user for revising the information;
determining whether the user made the recommendation; and
storing data corresponding to whether the user implemented the recommendation.

9. The non-transitory machine-readable medium of claim 8, wherein the method further comprises receiving revised information for the product and listing the product on behalf of the user based on the revised information.

10. The non-transitory machine-readable medium of claim 8, wherein the one or more hardware processors further determines what recommendation to make for the user based on at least one of a user action from a previous recommendation, listing information for a related product, and type of product.

11. The non-transitory machine-readable medium of claim 8, wherein the information comprises a written description, a photo, a UPC code, service policies and a price.

12. The non-transitory machine-readable medium of claim 8, wherein the recommendation is to revise at least one of a written description, a photo, a UPC code, service policies, and a price.

13. The non-transitory machine-readable medium of claim 8, wherein the recommendation is based on a previous listing of related, sold product from a different user.

14. The non-transitory machine-readable medium of claim 8, wherein the data is used to make a subsequent recommendation to the user.

15. A method, comprising:
receiving, by one or more hardware processors of a service provider, information from a user about a product for listing with a service provider;
presenting, electronically by the one or more hardware processors, a recommendation to the user for revising the information;
determining, by the one or more hardware processors, whether the user made the recommendation; and
storing, in one or more non-transitory memories, data corresponding to whether the user implemented the recommendation.

16. The method of claim 15, further comprising receiving revised information for the product and listing the product on behalf of the user based on the revised information.

17. The method of claim 15, wherein the one or more hardware processors further determines what recommendation to make for the user based on at least one of a user action from a previous recommendation, listing information for a related product, and type of product.

18. The method of claim 15, wherein the information comprises a written description, a photo, a UPC code, service policies, and a price.

19. The method of claim 15, wherein the recommendation is to revise at least one of a written description, a photo, a UPC code, service policies, and a price.

21. The method of claim 15, wherein the recommendation is based on a previous listing of a related, sold product from a different user.

22. The method of claim 15, wherein the data is used to make a subsequent recommendation to the user.
